(19) United States
(12) Patent Application Publication
(10) Pub. No.: US 2018/0108079 A1
(43) Pub. Date: Apr. 19, 2018

(54) Augmented Reality E-Commerce Platform

(71) Applicant: RIVER VENTURES SPA, Santiago (CL)

(72) Inventor: Pablo Traub, Santiago (CL)

(21) Appl. No.: 15/730,494

(22) Filed: Oct. 11, 2017

Related U.S. Application Data
(60) Provisional application No. 62/407,956, filed on Oct. 13, 2016.

(51) Int. Cl. G06Q 30/06; G06T 19/00; G06K 9/00; H04W 4/02

(52) U.S. Cl. CPC G06Q 30/0643; H04W 4/02; G06K 9/00671; G06T 19/006

(57) ABSTRACT

Provided are computer-implemented methods and systems for implementing and utilizing an augmented reality (AR) platform. The AR platform may include a first user interface, a second user interface, a processor, and an artificial intelligence (AI) module. The first user interface may be configured to receive commercial data from a first user. The commercial data may be associated with a location. The processor may be configured to automatically create an AR overlay for the location based on the commercial data. The second user interface may be associated with an AR-enabled device and configured to render the AR overlay superimposed over a real-time view of the location. The location may be viewable by a second user through the AR-enabled device. The AR Platform may further include an AI module including a bot configured to facilitate interactions between the first user and the second user.

### CROSS-REFERENCE TO RELATED APPLICATION

The present utility patent application is related to and claims the priority benefit under 35 U.S.C. 119(e) of U.S. provisional application No. 62/407,956, filed on Oct. 13, 2016, and titled “AUGMENTED REALITY E-COMMERCE PLATFORM.” The disclosure of this provisional application is incorporated herein by reference for all purposes to the extent that such subject matter is not inconsistent herewith or limiting hereof.

### FIELD

The application relates generally to data processing and, more specifically, to an augmented reality e-commerce platform.

### BACKGROUND

Augmented reality (AR) generally involves creating a live view of a real-world environment with superimposed sensory input in a form of sound, video, or image. With the help of AR technology and AR software development kits, AR-enabled devices such as smartphones, tablets, head-mounted display devices, AR-enabled eyeglasses, AR-enabled head-up display devices, and contact lenses, virtual information about the environment and surrounding objects can be superimposed on the live view to allow users of the AR-enabled devices to access and perceive additional information, such as sounds and visuals that would not be available otherwise. AR-enabled mobile computing devices conventionally use sensory input from a camera and microelectromechanical system sensors, such as an accelerometer, a Global Positioning System (GPS) module, a compass, and so forth. The sensory input can be used for visualizing information related to objects around the user.

Currently, in order for a business, such as a real-estate agency or a merchant, to create an AR solution, professional AR developers need to be employed. The professional AR developers can use specialized software development kits to create custom specific AR software and an AR interface based on specific business requirements. However, hiring the professional AR professionals for developing the AR technical solutions is time consuming and cost-prohibitive for most business.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

Provided are computer-implemented methods and systems for implementing and utilizing an AR platform. In some example embodiments, a system for creating an AR platform may include a first user interface, a second user interface, a processor, and an artificial intelligence (AI) module. The first user interface may be configured to receive commercial data from a first user. The commercial data may be associated with a location. The processor may be configured to automatically create an AR overlay for the location based on the commercial data. The second user interface may be associated with an AR-enabled device and configured to render the AR overlay superimposed over a real-time view of the location. The location may be viewable by a second user through the AR-enabled device. The AI module may include a bot configured to facilitate interactions between the first user and the second user based on the analysis.

In some example embodiments, a method for creating an AR platform may commence with receiving, via a first user interface, commercial data from a first user. The commercial data maybe associated with a location. The method may continue with automatically creating, by a processor, an AR overlay for the location based on the commercial data. The method may further include rendering, via a second user interface associated with an AR-enabled device, the AR overlay superimposed over a real-time view of the location. The location may be viewable by a second user through the AR-enabled device.

Additional objects, advantages, and novel features will be set forth in part in the detailed description section of this disclosure, which follows, and in part will become apparent to those skilled in the art upon examination of this specification and the accompanying drawings or may be learned by production or operation of the example embodiments. The objects and advantages of the concepts may be realized and attained by means of the methodologies, instrumentalities, and combinations particularly pointed out in the appended claims.

### BRIEF DESCRIPTION OF THE DRAWINGS

Embodiments are illustrated by way of example, and not limitation, in the figures of the accompanying drawings, in which like references indicate similar elements.

FIG. 1 illustrates a block diagram showing an environment within which an AR platform may be implemented, in accordance with an example embodiment.

FIG. 2 is block diagram showing various modules of an AR platform, in accordance with an example embodiment.

FIG. 3 is a flow chart illustrating a method for using an AR platform, in accordance with an example embodiment.

FIG. 4 illustrates a user interface shown on an AR-enabled device, according to an example embodiment.

FIG. 5 illustrates a user interface shown on an AR-enabled device, according to an example embodiment.

FIG. 6 illustrates a user interface shown on an AR-enabled device, according to an example embodiment.

FIG. 7 illustrates a user interface shown on an AR-enabled device, according to an example embodiment.

FIG. 8 shows a schematic illustration of actions performed by a first user of an electronic device, according to an example embodiment.

FIG. 9 shows a schematic illustration of actions performed by a second user of an electronic device, according to an example embodiment.

FIG. 10 illustrates a diagrammatic representation of an example machine in the form of a computing system within which a set of instructions for causing the machine to perform any one or more of the methodologies discussed herein is executed.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

The techniques of the embodiments disclosed herein may be implemented using a variety of technologies. For example, the methods described herein may be implemented in software executing on a computing system or in hardware utilizing either a combination of microprocessors or other specially designed application-specific integrated circuits, programmable logic devices, or various combinations thereof. In particular, the methods described herein may be implemented by a series of computer-executable instructions residing on a storage medium, such as a disk drive or computer-readable medium. It should be noted that methods disclosed herein can be implemented by a computer (e.g., a desktop computer, a tablet computer, a laptop computer, and so forth), a game console, a handheld gaming device, a cellular phone, a smart phone, a smart television system, and so forth.

As outlined in the summary, the embodiments of the present disclosure are directed to implementing and using an AR e-commerce platform. According to example embodiments, systems and methods of the present disclosure provide a device-agnostic platform that allows commercial owners and business people to electronically upload and advertise information and also allows consumers to search, find, and view relevant information using AR technology that is normally available to the consumers. Specifically, a first user, e.g., a commercial owner, can upload information related to a physical item associated with a business. The information may include a location and description of the physical item and various offers for customers. The AR platform may create, based on the received location data and advertisement information, an AR overlay for the location associated with the physical item.

According to example embodiments of the disclosure, when a second user, e.g. a customer, uses an AR-enabled device in a proximity of the location, the AR overlay can be superimposed over a real-time view of the location viewable by the second user via the AR-enabled device. Specifically, the second user may point a camera of the AR-enabled device at the real environment in front of the second user and the AR overlay can be superimposed over the live view of the real environment. The AR overlay may include a plurality of items, such as icons, indicators, menus, and the like. The second user may interact with the AR overlay by manipulating the items shown on the AR overlay. The AR-enabled device may sense the commands of the second user in respect of the items on the AR overlay and perform the operations corresponding to the commands.

According to example embodiments of the disclosure, the platform can be utilized in various industries, such as restaurants, retail stores, real estate, and so forth. For example, a restaurant owner can use the AR technology, disclosed herein, to display information concerning specials or menu items, shop owners can advertise discounts or loyalty programs, for example, on a virtual billboard, and real estate agents can list items related to a real estate property and use the AR technology to allow potential buyers to see additional information about the real estate property. The AR platform may enable business owners to leverage AR technical solutions without the need for hiring software developers and developing custom software.

According to example embodiments of the disclosure, the AR overlay provided by the AR platform does not require any additional software development by customers. Instead, the customers can use AR platform to automatically create AR solutions without hiring software developers for developing custom AR solutions.

In an example embodiment, an owner of an apartment can be registered with the AR platform of the present disclosure. The owner can log into a user account and upload information related to the apartment, such as a description and a location. The owner does not need to be physically present at the location while uploading the information for the apartment. In an example embodiment, the owner may manually input the location of the apartment. In another example embodiment, the owner may be physically present at the location when uploading the information for the apartment and check in at the location to provide, to the AR platform, the location information related to the apartment.

The uploaded information can be made available to all users who are searching for an apartment in a proximity of the location. Specifically, the user may use the camera of an AR-enabled device and view the real-live objects associated with the location. Based on the information provided by the owner, an AR overlay can be generated and shown to the user on the AR-enabled device. The AR overlay can be superimposed over the real-time view. The AR overlay may include an indicator related to the apartment. Upon selection of the indicator, the user may read additional information for the apartment, obtain contact information for the owner, and contact the owner.

In a further example embodiment, a restaurant owner may upload information related to specific promotions, specific menus for lunch time, specific dishes, and indicate the location of the restaurant. Any person who looks at the location of the restaurant using the AR-enabled device, may see indicators superimposed over a real-life view of the location. The indicators may show the information uploaded by the restaurant owner. For example, a person may look at the restaurant through a camera of a smartphone camera and see promotional information displayed over the real-time view of the restaurant at which the person is currently looking.

With the use of advertisements embedded into an AR overlay and shown on AR-enabled devices to users located in a proximity of a location associated with the advertisements, the owner can advertise to a plurality of users at the same time based on their location. Thus, the advertisements shown via AR-enabled devices may specifically target users located in a proximity of a business associated with the advertisements.

In some example embodiments, instead of providing manual input, a user can perform a search with an AR-enabled device by pointing a camera of the AR-device at a location of interest while an AR interface is open on the AR-device. The activation of the camera of the AR-enabled device when the AR interface is open on the AR-device can automatically trigger a search request for goods and services related to a business at the location of interest. The search results can be shown to the user in a form of an AR overlay superimposed over a real-time view of the location viewable by the user via the AR-device.

In some embodiments, interactions of users with the AR-enabled device and the AR overlay, as well as user behavioral data and personal data may be continuously collected by the AR platform. Specifically, the AR platform may include a bot running as part of an AI module of the AR platform. The bot may be responsible for collecting information related to the users of the AR-enabled device. The bot may collect data related to interactions of the users with regard to the AR-enabled device, the AR overlay, and various application of the AR-enabled device, data related to the AR-enabled device, such as location data, web search history, web browser history, and so forth.

The collected user behavioral data and personal data of a user may include places the user has visited, purchases made by the user, data from personal profiles of the user in social networks, data from third-party resources, e.g., statistical data related to a geographical location or places the user has visited, ratings of real-live objects the user has visited, and so forth.

Thus, the information used for creation of the AR overlay is not limited to commercial information associated with a business, but also includes temporal information, merchant information, behavioral information, statistical information, and other information that may be collected and/or determined by the AI module. The collected information may be used for customizing the AR overlay for a specific user. The customization may include selecting offers corresponding to user needs and displaying targeted offers, at specific times, and related to specific types of goods and services.

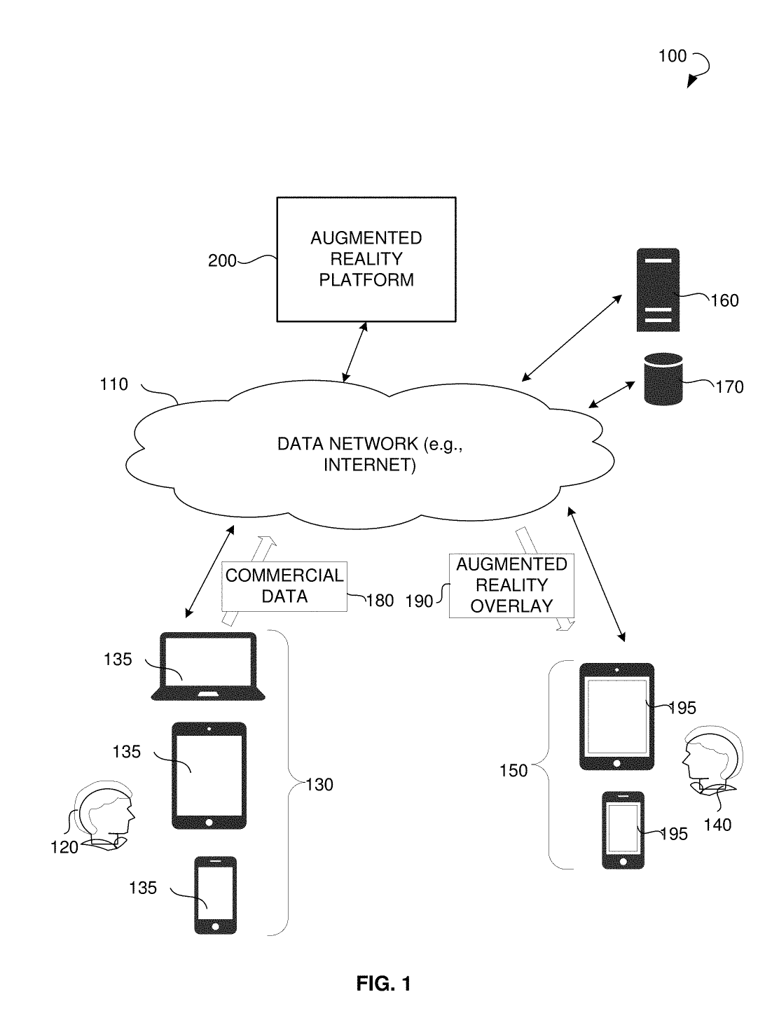

Referring now to the drawings, FIG. 1 illustrates an environment 100 within which methods and systems for implementing and utilizing an AR platform can be implemented. The environment 100 may include a data network 110 (e.g., an Internet), a first user 120, one or more electronic devices 130 associated with the first user 120, a second user 140, one of more electronic devices 150 associated with the second user 140, an AR platform 200, a server 160, and a database 170.

The first user 120 may include a person, such as a business owner, a retailer, an advertiser, a property owner, and any other person or organization that would like to use the AR platform 200 to sell, advertise, or provide information related to their goods and services. The first user 120 may be an administrator of one or more electronic devices 130. The electronic devices 130 associated with the first user 120 may include a personal computer (PC), a tablet PC, a laptop, a smartphone, and so forth. Each of the electronic devices 130 may include a first user interface 135.

The second user 140 may include a person who is a prospective buyer of goods or services provided by the first user 120. For example, the second user 140 may include a customer, a prospective tenant, a prospective real estate buyer, a retail shopper, a restaurant patron, and so forth.

The electronic devices 150 associated with the second user 140 may include an AR-enabled device, such as a smartphone, a tablet PC, a head-mounted display device, AR-enabled eyeglasses, a head-up display device, contact lenses, an AR-enabled windshield, an AR headset, and so forth. The AR-enabled device may be equipped with sensors, such as a camera, a GPS module, an accelerometer, a compass, and so forth. The sensors may be configured to determine the location of the AR-enabled device, provide a live view of an environment, sense interaction of the second user 140 with the AR-enabled device, and so forth.

Each of the electronic devices 130, electronic device 150, and the platform 200 may be connected to the data network 110. The data network 110 may include the Internet or any other network capable of communicating data between devices. Suitable networks may include or interface with any one or more of, for instance, a local intranet, a corporate data network, a data center network, a home data network, a Personal Area Network, a Local Area Network (LAN), a Wide Area Network (WAN), a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The data network can further include or interface with any one or more of a Recommended Standard 232 (RS-232) serial connection, an IEEE-1394 (FireWire) connection, a Fiber Channel connection, an IrDA (infrared) port, a Small Computer Systems Interface connection, a Universal Serial Bus (USB) connection or other wired or wireless, digital or analog interface or connection, mesh or Digi® networking. The data network 110 may include a network of data processing nodes, also referred to as network nodes, that may be interconnected for the purpose of data communication.

The AR platform 200 may be connected to the server 160. The server 160 may include a web service server, e.g., Apache web server. The platform 200 may further be connected to the database 170. In an example embodiment, the information related to the first user 120 and the second user 140 may be stored in the database 170.

The first user 120 may use one of the electronic devices 130 to provide commercial data 180 to the platform 200. In an example embodiment, the first user 120 may use an application executed on the electronic device 130 to upload the commercial data 180, for example, information relating to a commercial advertisement of the first user 120. The platform 200 may process the commercial data 180 and generate an AR overlay 190. The AR overlay 190 may be integrated into the real-world environment viewable via a real-time view 195 of the digital device 150 by the second user 140. The second user 140 can then view and access the commercial data 180 shown on the AR overlay 190 over the real-time view 195 of the electronic device 150.

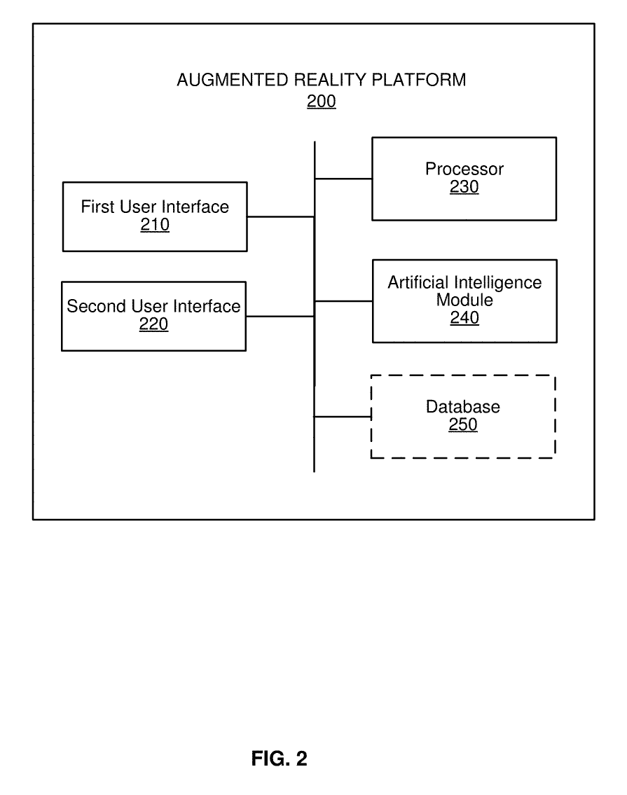

FIG. 2 shows a block diagram illustrating various modules of a platform 200 for creating an AR platform, according to an example embodiment. The platform 200 may include a first user interface 210, a second user interface 220, a processor 230, an AI module 240, and, optionally, a database 250.

The first user interface 210 can be associated with a digital device 130 shown in FIG. 1 and can be configured to receive commercial data from a first user. The first user may enter the commercial data into a data entry form of the first user interface 210. The commercial data may be associated with a location. The location may be associated with goods and services provided by the first user, a real estate property, a restaurant, an office, or any organization associated with the first user. In an example embodiment, the commercial data may include at least one commercial advertisement and include restaurant information, special promotions, real estate property information, loyalty program information, descriptive information, and so forth. Additionally, the first user may enter preferences related to prospective customers to whom the commercial data is to be shown, preferences related to a timing of display of the commercial data, for example, specific time of the day, and so forth.

The first user interface may include at least one of the following: a registration selector, a location selector, a data entry form to input the commercial data, and a management module. The location selector of the first user interface may be used for entering or selecting the location by the first user. The management module may be configured to send and receive messages between the first user and a second user as well as to update the commercial data.

The processor 230 may be configured to automatically create an AR overlay for the location based on the commercial data. In an example embodiment, the AR overlay may be implemented using an AR Software Development Kit.

The second user interface 220 may be associated with an AR-enabled device, such as a digital device 150 shown on FIG. 1. The AR-enabled device may be associated with the second user and include one of the following: a smartphone, a tablet, a head-mounted display device, AR-enabled eyeglasses, a head-up display device, contact lenses, an AR-enabled windshield, an AR headset, and the like.

The second user interface 220 may be configured to render the AR overlay superimposed over a real-time view of the location. The location may be viewable by the second user through the AR-enabled device. For example, the second user may view the location via a camera of a smartphone or via AR-enabled eyeglasses. The AR overlay may include at least one of the following: virtual sensory input, virtual information about the environment and surrounding objects, sounds, visuals, videos, images, advertisements, information display, menu items, promotions, loyalty program information, a virtual billboard, additional location information, restaurant information, pricing information, descriptive information, and so forth. The second user interface 220 may be configured to enable user interactions of the second user with the AR overlay, for example, by providing commands supported by the AR-enabled device. In an example embodiment, the commands may be provided by the second user using voice, body movements, gestures, touch, and so forth.

In an example embodiment, the AR overlay may be rendered based on location settings of the AR-enabled device and search parameters received by the AR-enabled device. Specifically, in the example embodiment, the processor 230 may be configured to receive a search request from the AR-enabled device. The search request may include an indication of an activation of the real-time view of the location by the AR-enabled device. Therefore, the activation of the real-time view of the location by the AR-enabled device may be considered as the search request for additional information with regard to items viewable by the user. In this embodiment, the rendering of the AR overlay may be performed based on the indication of the activation of the real-time view of the location by the AR-enabled device.

In further example embodiments, the processor 230 may be configured to determine a current location of the AR-enabled device. The current location of the AR-enabled device may be sensed by sensors of the AR-enabled device and transmitted to the processor 230. The processor 230 may be further configured to match the current location of the AR-enabled device to the location. In this embodiment, the rendering of the AR overlay superimposed over the real-time view of the location may be performed when the current location of the AR-enabled device matches the location associated with the commercial data.

Users of the AR platform 200, such as property owners, can be registered with the AR platform 200 and have accounts created. In an example embodiment, the registration may be performed using a registration selector of the first user interface. Thus, all information provided by the users with regard to goods and services may be stored in a database and associated with the user account. The information provided by the users may be shown in a form of advertisement to any users of AR-devices at the location of the goods and services. Thus, the users searching for goods and services do not need to register with the AR platform 200.

In an example embodiment, the AI module 240 may assist with developing dynamic personal profiles of the users as the users interact with the AR platform 200. The AI module 240 may include a bot configured to interact with users, collect, process, and analyze data, as well as facilitate interactions between the first user and the second user based on the analysis. Specifically, the bot may gather information about the activity, behavior, and actions of users with regard to the application associated with the AR platform 200 and running on the AR-enabled device, as well as any other user-related data, for example, activity with regard to real-live objects. The activity of the user may be determined based on geospatial and behavioral information collected by the AR-enabled device, geospatial sensors or any other sensor of the AR-enabled device, or received from third parties. Additionally, the bot may collect information related to a merchant, such as goods and services provided by the merchant, loyalty programs provided of the merchant, data related to users that purchase goods or services from the merchant, and so forth. The AR platform 200 may associate the collected information with the user.

The collected information may also include routes that a user travels during the day, places that the user likes to visit at specific times of the day, frequency of visiting of these places, and so forth. The AI module may analyze the collected information and the results of the analysis can be used for customizing the AR overlay for the user. Specifically, the collected information can be used to select specific advertisements, promotions, or offers customized for specific needs of the user. Thereafter, only the selected specific advertisements, promotions, or offers are displayed, via the AR overlay, to the user.

The database 250 may be configured to store at least one of the following: the first user data, the second user data, the commercial data, the AR overlay, and any other data related to the AR platform 200.

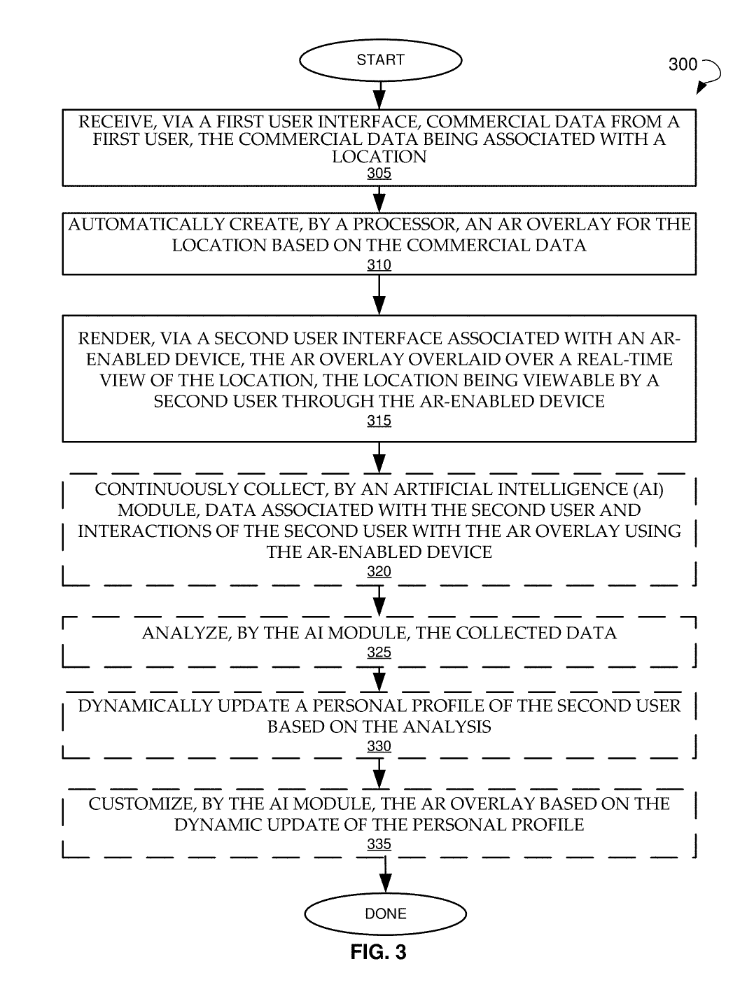

FIG. 3 shows a process flow diagram of a method 300 for creating an AR platform, according to an example embodiment. In some embodiments, the operations may be combined, performed in parallel, or performed in a different order. The method 300 may also include additional or fewer operations than those illustrated. The method 300 may be performed by processing logic that may comprise hardware (e.g., decision making logic, dedicated logic, programmable logic, and microcode), software (such as software run on a general-purpose computer system or a dedicated machine), or a combination of both.

The method 300 may commence with receiving, via a first user interface, commercial data from a first user at operation 305. The commercial data may be associated with a location. The method 300 may continue with automatically creating, by a processor, an AR overlay for the location based on the commercial data at operation 310.

The method 300 may further include rendering, via a second user interface associated with an AR-enabled device, the AR overlay superimposed over a real-time view of the location at operation 315. The location may be viewable by a second user through the AR-enabled device.

In an example embodiment, the method 300 may include receiving a search request from the second user. The receiving of the search request may include receiving an indication of an activation of the real-time view of the location by the AR-enabled device. In this embodiment, the rendering of the AR overlay may be performed based on the indication of the activation of the real-time view of the location by the AR-enabled device.

The method 300 may further include determining a current location of the AR-enabled device and matching the current location of the AR-enabled device to the location. In this embodiment, the rendering of the AR overlay superimposed over the real-time view of the location may be performed based on the match of the current location of the AR-enabled device and the location, for example, when the current location of the AR-enabled device is the same as the location associated with the commercial data.

The method 300 may optionally include an operation 320, at which an AI module is to continuously collect data associated with the second user and interactions of the second user with the AR overlay through the AR-enabled device. At operation 325, the AI module may analyze the collected data. At operation 330, a personal profile of the second user may be dynamically updated based on the analysis. The personal profile may be created by the AR platform 200 for the second user and may store all data collected for the second user. At operation 335, the AR overlay may be customized by the AI module based on the updated personal profile.

In an example embodiment, the second user may be classified based on the personal profile. The customization of the AR overlay may be performed based on the classification of the second user. Specifically, the AI module may be used to categorize offers for users according to personal profiles of the users, as well as to categorize users according to the personal profiles of the users. The customization of the offers may include selecting specific offers for the second user based on the data collected for the second user. In a further example embodiment, the categories may be assigned to the second user based on preferences entered by the first user in respect of persons to which the commercial data is to be shown.

In an example embodiment, the customization of the AR overlay may include selecting one or more offers for the second user. The one or more offers may include one or more of the following: marketing materials, pricing materials, informational materials, virtual sensory input, virtual information concerning the environment and surrounding objects, sounds, visuals, videos, images, advertisements, information display, menu items, promotions, loyalty program information, virtual billboards, additional location information, restaurant information, and so forth. The one or more offers may be selected based on the commercial data and preferences provided by the first user. The selected one or more offers may be displayed via the AR overlay to the second user.

The method 300 may further include continuously collecting, by the AI module, behavioral data of the second user with regard to one or more real-live objects. For examples, the AI module may collect data in respect of locations visited by the second user. Based on the behavioral data, one or more offers may be selected for providing to the second user using the AR overlay shown via the AR-enabled device.

Additionally, information collected in respect of the second user may include locations the second user visits during the day, key words the second user enters in a search field for an Internet browser or web pages, goods and services previously purchased by the second user online or offline, historical behavior of the second user, and so forth. The collected information may be used by the AI module to provide one or more suggestions to the second user. For example, advertisements related to promotions of a restaurant located in a proximity of the second user may be displayed to the second user via the AR-enabled device around lunchtime.

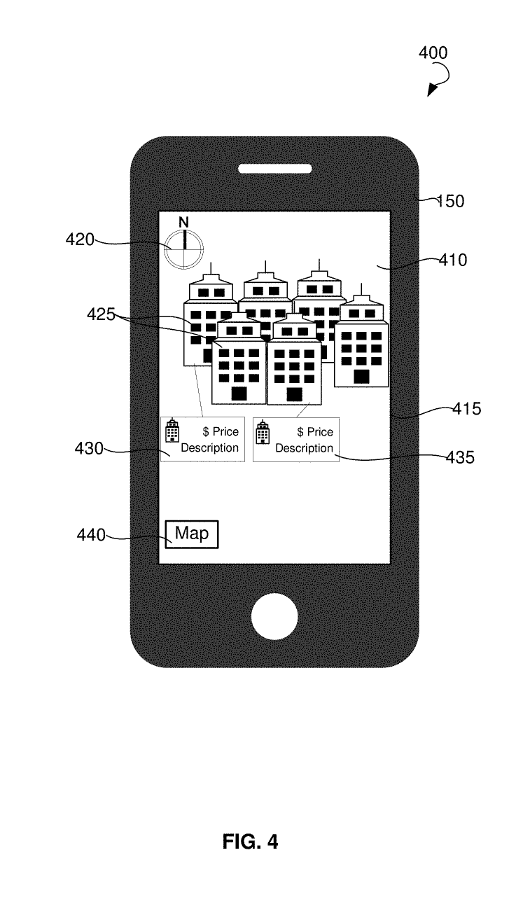

FIG. 4 shows an AR overlay displayed on an AR-enabled device 400, according to an example embodiment. The AR-enabled device 400 may include a smartphone and may be associated with a user shown as a second user 140 on FIG. 1. The user may include a user that performs a search with the AR-enabled device 400. In an example embodiment, the user may search for a real estate property. Specifically, the user may search for the real estate property located in a proximity of the current location of the AR-enabled device 400. Sensors of the AR-enabled device 400 may track the current location of the AR-enabled device 400 and send the data related to the current location of the AR-enabled device 400 to the AR platform.

The user may use the AR-enabled device 400 to receive a real-time view 410 of the location in a proximity of the AR-enabled device 400. For example, the user may use a camera of the AR-enabled device 400 to receive the real-time view 410 of an object near the AR-enabled device 400 via a user interface 415 of the AR-enabled device 400. The user interface 415 may also show an AR overlay superimposed over the real-time view 410. The AR overlay may include location data 420, such as compass data, coordinates, altitude, and so forth. With the real-time view 410, the user may view a plurality of buildings 425 located in a proximity of the location of the AR-enabled device 400.

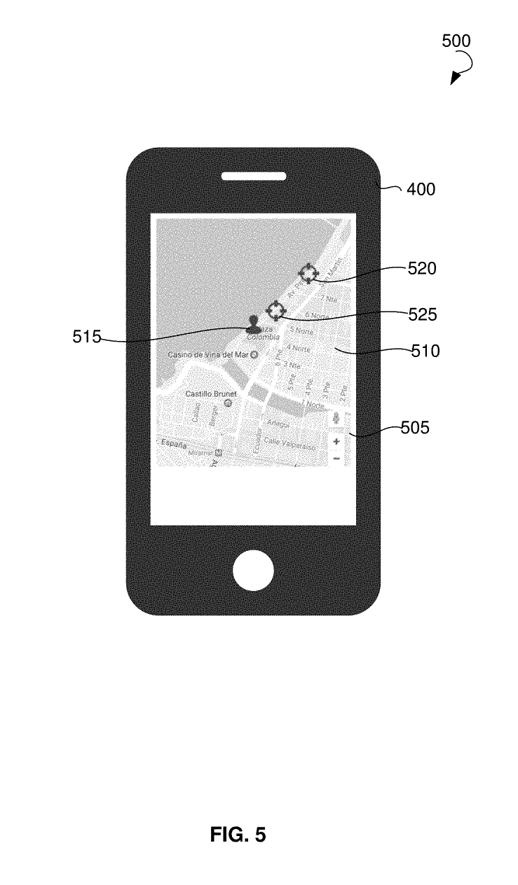

A property owner may provide commercial data in respect of one or more items of real estate property located in the plurality of buildings 425. Specifically, the commercial data may include information related to real estate property, such as a location of the real estate property, description, price, contact information, and so forth. Therefore, when viewing the location in a proximity of the real estate property by the user, the user may see the AR overlay that further includes the information related to the real estate property. The information related to the real estate property may be superimposed over the real-time view of the location in a form of indicators 430 and 435 related to the real estate property of the property owner. Specifically, the indicators 430 and 435 may be shown as parts of the AR overlay superimposed over the real-time view 410 of the location. The indicators 430 and 435 may include data related to the real estate property, such as a price, description, picture, contact information of the property owner, and so forth. The indicators 430 and 435 may show specific locations of the real estate property, such as houses in which the real estate property is located. The user interface 415 may further include a button 440 shown as “map” button. Upon selecting the button 440 by the user, a user interface shown on FIG. 5 may be activated.

Thus, the AR platform that provides the AR overlay displayed on an AR-enabled device 400 may be used for real estate transactions between real estate agents and customers and assist real estate brokers in selling the real estate property, or may be used as a virtualized real estate agent.

FIG. 5 shows a schematic illustration 500 of a user interface 505 of the AR-enabled device 400, according to an example embodiment. The user interface 505 may be displayed upon selection of the button 440 shown on FIG. 4 by the user. The user interface 505 may show a map 510 of an area in a proximity of the location of the real estate property. An indicator 515 showing a current location of the user may be shown on the map 510. Moreover, indicators 520 and 525 showing locations of the real estate property in a proximity of the location of the user may be shown on the map 510. The user may select one of indicators 520 and 525, for example, by touching one of the indicators 520 and 525.

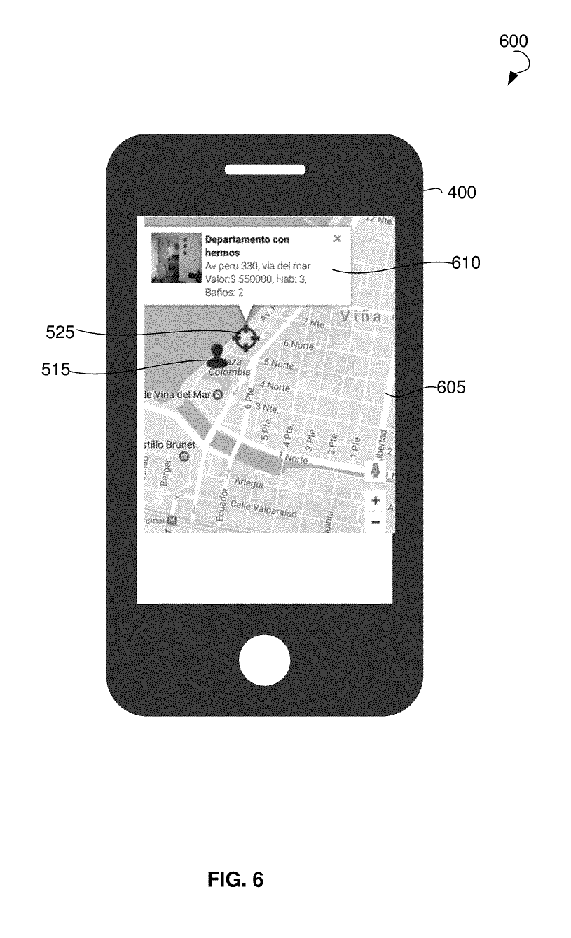

FIG. 6 shows a schematic illustration 600 of a user interface 605 of the AR-enabled device 400, according to an example embodiment. The user interface 605 may be displayed upon selection of the indicator 525 shown on FIG. 5 by the user. The user interface 605 may show a box 610. The box 610 may contain data related to the real estate property shown by the indicator 525. The data related to the real estate property may include an image, an address, a description, a price, and so forth.

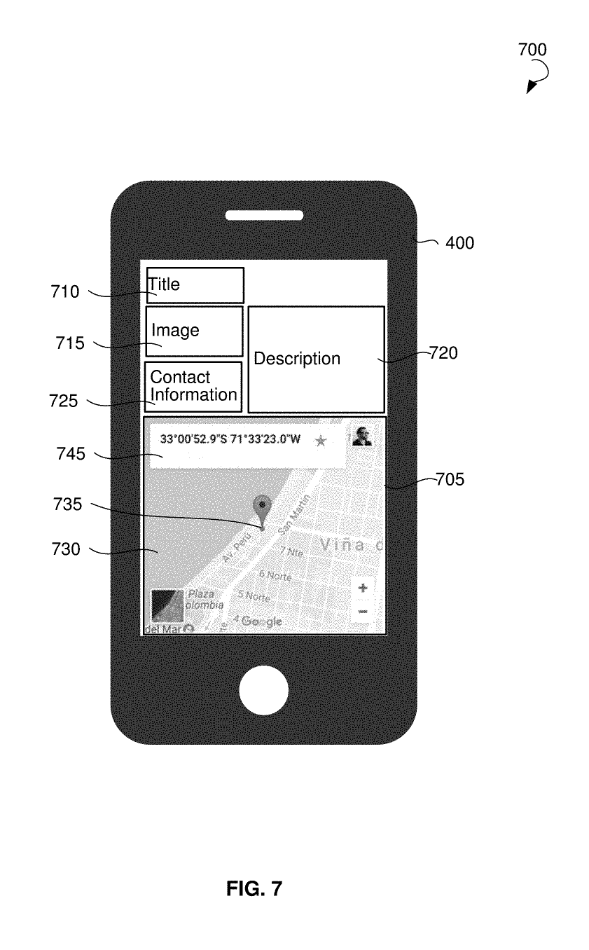

Referring back to FIG. 4, the user may select one of the indicators 430 and 435 to view additional information related to the real estate property associated with each of the indicators 430 and 435. FIG. 7 shows a schematic illustration 700 of a user interface 705 of the AR-enabled device 400 displayed upon selection of the indicator 435 (shown on FIG. 4) by the user, according to an example embodiment. The user interface 705 may display additional information related to the real estate property associated with the indicator 435. Specifically, the user interface 705 may show a title 710 related to the real estate property, for example, a brief description of the real estate property. The user interface 705 may further show an image 715 of the real estate property, a description 720 of the real estate property, contact information 725 of the property owner, and a map 730. The map 730 may show an indicator 735 showing the location of the real estate property. The map 730 may further show coordinates 745 of the real estate property.

In an example embodiment, the selection of buttons and indicators may be performed using motions or gestures corresponding to the AR-enabled device, such as clicking, pointing, grasping, head motion, hand motion, eye motion, sound command, finger pointing performed by the user, and so forth.

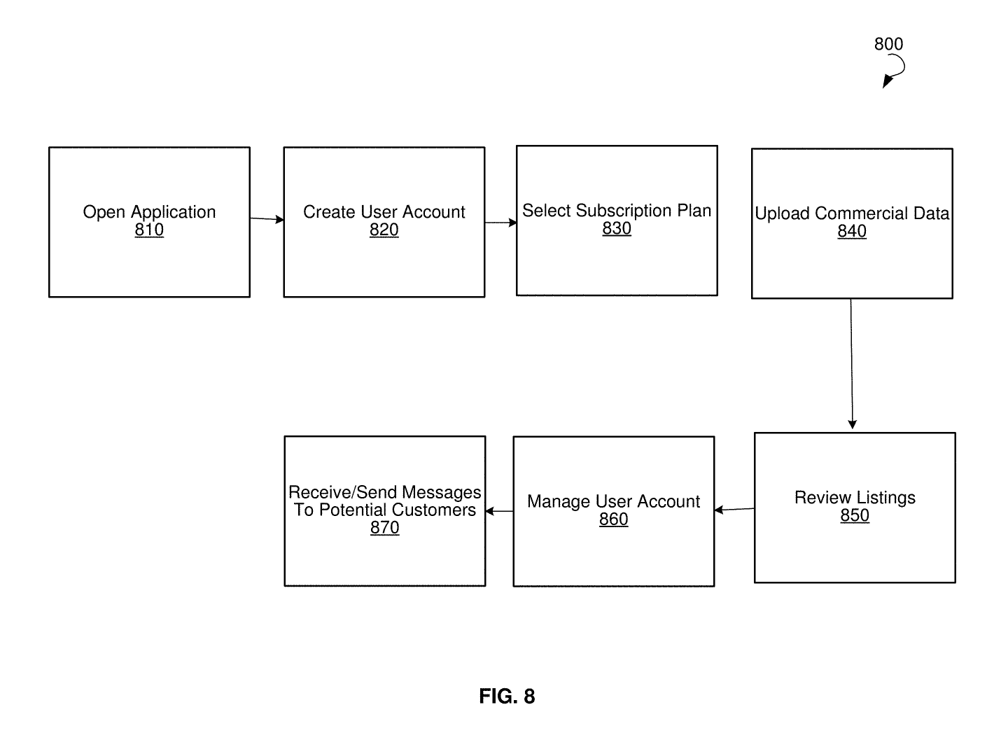

FIG. 8 shows a schematic illustration 800 of actions performed by a first user via an electronic device of the first user, according to an example embodiment. The first user may be a real estate agent that advertised one or more real estate properties. The first user may open an application associated with the platform 200 and running on the electronic device of the first user, as shown in block 810. The first user may then create a user account, as shown in block 820. All further data provided by the first user may be associated with the user account. Upon creating the user account, the first user may select a subscription plan, as shown by block 830. The subscription plan may include a number of paid advertisements, a level of service to the provided to the first user, and so forth. Additionally, the subscription plan may include obtaining information collected in respect of a plurality of users. In this embodiment, the AI module of the platform 200 may generate automated dynamic marketing and pricing materials for the first user based on the information gathered by the AI module. For example, information collected by the platform 200 in respect of persons may include places persons visit at a specific time of the day, promotions that the person selects at a specific time of the day, preferences of persons buying the goods and the like. The collected information may be obtained by the first user based on the subscription plan. The first user may use the information collected by the platform 200 for creating pricing policies related to goods and services of the first user, creating advertisements for specific categories of users, creating advertisements for specific dates or time of the day, and so forth.

The first user may further select payment options at block 830. The subscription plan and payment options (e.g., a payment schedule) may be selected by the first user based on a number of items (e.g., a real estate property) the first user wishes to list on the platform 200. In an example embodiment, the first listing may be free, and after submitting the first listing, a paid subscription plan may be activated for the first user. The first user may be able to upload information concerning the real estate property that the first user wishes to advertise at block 840.

The first user may upload the information into a prebuilt data entry form that may include, for example, price, location, property description, photos, and so forth. The information provided by the first user may be stored in a database and converted into an AR overlay by the platform 200. The first user may review listings of real estate property associated with the first user at block 850. At block 860, the first user may manage the user account, e.g., change information related to the real estate property uploaded by the first user, add additional listings, delete listings, select another subscription plan, and so forth. The first user may also send and receive messages to and from potential customers, as shown by block 870.

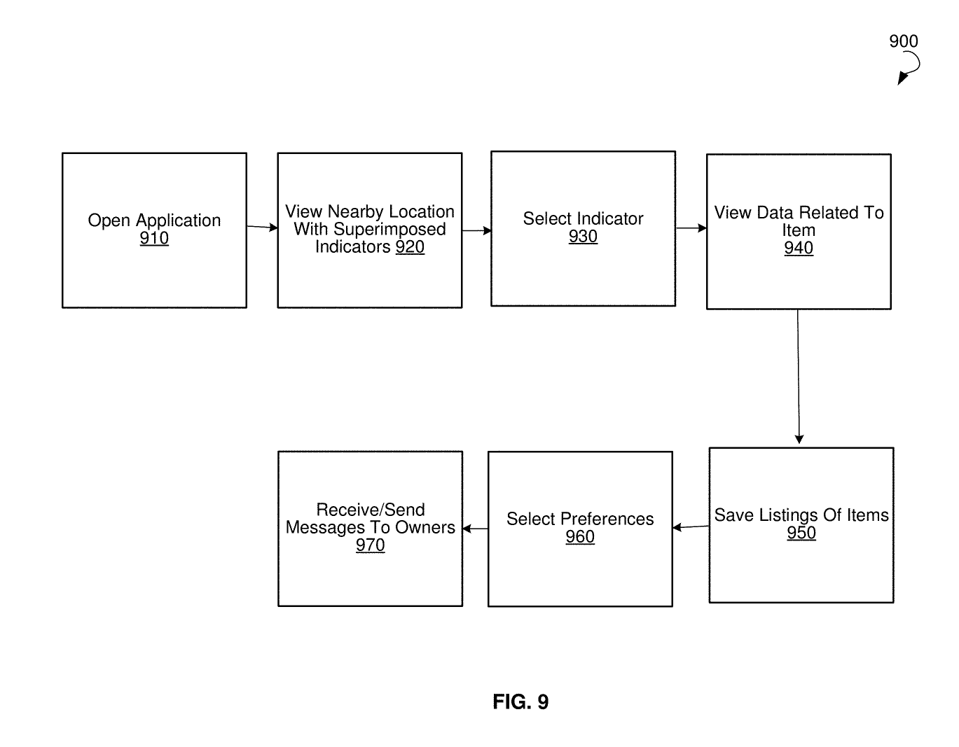

FIG. 9 shows a schematic illustration 900 of actions performed by a second user via an electronic device of second user, according to an example embodiment. The second user may be a customer who wants to buy a real estate property item. The second user may open an application associated with the platform 200 and running on the electronic device of the second user, as shown in block 910. The electronic device of the second user may be an AR-enabled device. The second user may use the AR-enabled device to view, at block 920, a nearby location using a camera of the AR-enabled device. The AR overlay may be shown on the AR-enabled device. The AR overlay may have indicators superimposed on the real-time view of the location. The indicators may relate to real estate property listings of the property owner. The real estate property listings indicators of which are shown to the second user may have the location that is the same as or close to the current location of the AR-enabled device. The current location of the AR-enabled device may be determined by a GPS sensor, accelerometer, or compass of the AR-enabled device. The second user may move the AR-enabled device to change a direction of viewing, and the camera of the AR-enabled device may show another location corresponding to a new direction of viewing. Therefore, by directing the camera in a different direction, the second user may search for real estate property items located in a proximity of the second user. Specifically, when the real estate property on which the information is provided by the property owner appears within the field of view of the camera, an indicator related to the real estate property is shown on the real-time view on the screen of the AR-enabled device. When the indicator appears on the screen, the second user may select the indicator, as shown by block 930. Upon selection of the indicator, the second user may view data related to a real estate property item, as shown by block 940. The second user may save one or more listings related to real estate property, as shown by block 950, for further review and comparison. In an example embodiment, the second user may select preferences related to the search, such as select specific types of real estate property, price range, floor, and so forth, as shown in block 960. Additionally, the preferences of the second user may be determined by an AI module. Both the preferences selected by the second user and the preferences collected by the AI module may be used for customizing a search and the AR overlay for the second user.

The second user may also send and receive messages to and from property owners, as shown by block 970, as well as may contact the property owners associated with the property listing. The messages may be sent via email, phone, chat associated with the platform 200, and the like.

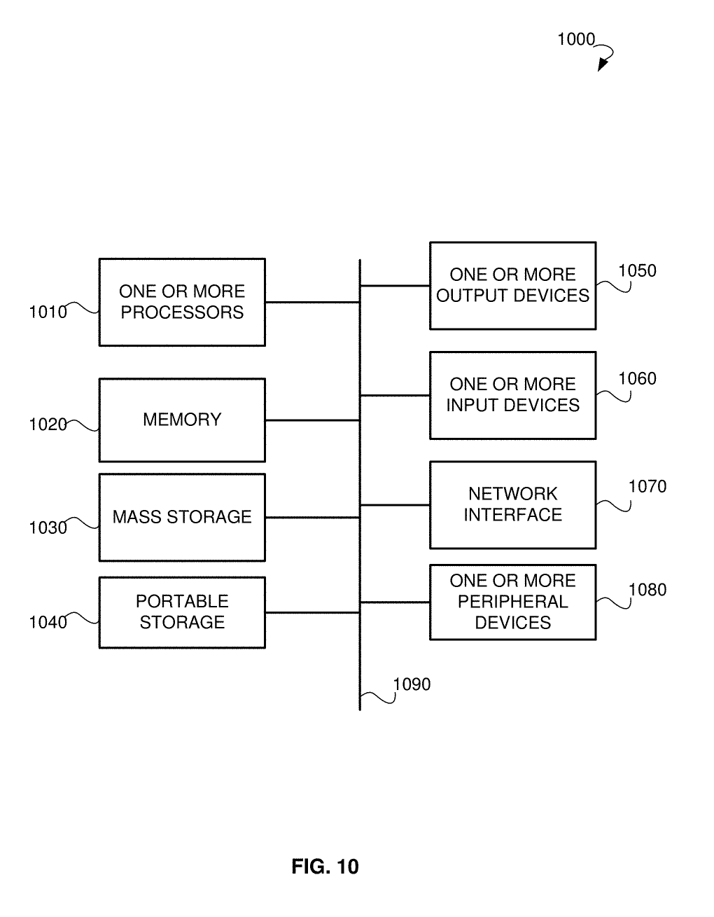

FIG. 10 illustrates an exemplary computing system 1000 that may be used to implement embodiments described herein. The computing system 1000 of FIG. 10 may include one or more processors 1010 and memory 1020. Memory 1020 stores, in part, instructions and data for execution by the one or more processors 1010. Memory 1020 can store the executable code when the computing system 1000 is in operation. The computing system 1000 of FIG. 10 may further include a mass storage 1030, portable storage 1040, one or more output devices 1050, one or more input devices 1060, a network interface 1070, and one or more peripheral devices 1080.

The components shown in FIG. 10 are depicted as being connected via a single bus 1090. The components may be connected through one or more data transport means. One or more processors 1010 and memory 1020 may be connected via a local microprocessor bus, and the mass storage 1030, one or more peripheral devices 1080, portable storage 1040, and network interface 1070 may be connected via one or more input/output (I/O) buses.

Mass storage 1030, which may be implemented with a magnetic disk drive or an optical disk drive, is a non-volatile storage device for storing data and instructions for use by a magnetic disk or an optical disk drive, which in turn may be used by the one or more processors 1010. Mass storage 1030 can store the system software for implementing embodiments described herein for purposes of loading that software into memory 1020.

Portable storage 1040 operates in conjunction with a portable non-volatile storage medium, such as a compact disk (CD) or digital video disc (DVD), to input and output data and code to and from the computing system 1000 of FIG. 10. The system software for implementing embodiments described herein may be stored on such a portable medium and input to the computing system 1000 via the portable storage 1040.

One or more input devices 1060 provide a portion of a user interface. One or more input devices 1060 may include an alphanumeric keypad, such as a keyboard, for inputting alphanumeric and other information, or a pointing device, such as a mouse, a trackball, a stylus, or cursor direction keys. Additionally, the computing system 1000 as shown in FIG. 10 includes one or more output devices 1050. Suitable one or more output devices 1050 include speakers, printers, network interfaces, and monitors.

Network interface 1070 can be utilized to communicate with external devices, external computing devices, servers, and networked systems via one or more communications networks such as one or more wired, wireless, or optical networks including, for example, the Internet, intranet, LAN, WAN, cellular phone networks (e.g. Global System for Mobile communications network, packet switching communications network, circuit switching communications network), Bluetooth radio, and an IEEE 802.11-based radio frequency network, among others. Network interface 1070 may be a network interface card, such as an Ethernet card, optical transceiver, radio frequency transceiver, or any other type of device that can send and receive information. Other examples of such network interfaces may include Bluetooth®, 3G, 4G, and WiFi® radios in mobile computing devices as well as a USB.

One or more peripheral devices 1080 may include any type of computer support device to add additional functionality to the computing system 1000. One or more peripheral devices 1080 may include a modem or a router.

The components contained in the computing system 1000 of FIG. 10 are those typically found in computing systems that may be suitable for use with embodiments described herein and are intended to represent a broad category of such computer components that are well known in the art. Thus, the computing system 1000 of FIG. 10 can be a PC, hand held computing device, telephone, mobile computing device, workstation, server, minicomputer, mainframe computer, or any other computing device. The computer can also include different bus configurations, networked platforms, multi-processor platforms, and so forth. Various operating systems (OS) can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the example embodiments. Those skilled in the art are familiar with instructions, processor(s), and storage media.

It is noteworthy that any hardware platform suitable for performing the processing described herein is suitable for use with the example embodiments. The terms “computer-readable storage medium” and “computer-readable storage media” as used herein refer to any medium or media that participate in providing instructions to a central processing unit (CPU) for execution. Such media can take many forms, including, but not limited to, non-volatile media, volatile media, and transmission media. Non-volatile media include, for example, optical or magnetic disks, such as a fixed disk. Volatile media include dynamic memory, such as Random Access Memory (RAM). Transmission media include coaxial cables, copper wire, and fiber optics, among others, including the wires that include one embodiment of a bus. Transmission media can also take the form of acoustic or light waves, such as those generated during radio frequency and infrared data communications. Common forms of computer-readable media include, for example, a floppy disk, a flexible disk, a hard disk, magnetic tape, any other magnetic medium, a CD-read-only memory (ROM) disk, DVD, any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

In some embodiments, the computing system 1000 may be implemented as a cloud-based computing environment, such as a virtual machine operating within a computing cloud. In other embodiments, the computing system 1000 may itself include a cloud-based computing environment, where the functionalities of the computing system 1000 are executed in a distributed fashion. Thus, the computing system 1000, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud may be formed, for example, by a network of web servers that comprise a plurality of computing devices, such as the computing system 1000, with each server (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

Aspects of the present technology are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, methods and systems for implementing and using an AR platform have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense. There are many alternative ways of implementing the present technology. The disclosed examples are illustrative and not restrictive.

What is claimed is:

1. A system for creating an augmented reality (AR) platform, the system comprising:
a first user interface configured to receive commercial data from a first user, the commercial data being associated with a location;
a processor configured to automatically create an AR overlay for the location based on the commercial data;
a second user interface associated with an AR-enabled device configured to render the AR overlay superimposed over a real-time view of the location, the location being viewable by a second user through the AR-enabled device; and
an artificial intelligence (AI) module comprising a bot configured to facilitate interactions between the first user and the second user based on the analysis.

2. The system of claim 1, further comprising a database configured to store at least one of the following: the first user data, the second user data, the commercial data, and the AR overlay.

3. The system of claim 1, wherein the bot of the AI module is further configured to:
continuously collect data associated with the second user and interactions of the second user with the AR overlay through the AR-enabled device;
analyze the collected data;
dynamically update a personal profile of the second user based on the analysis; and
customize the AR overlay based on the updated personal profile.

4. The system of claim 1, wherein the processor is further configured to:
determine a current location of the AR-enabled device;
match the current location of the AR-enabled device to the location; and
render the AR overlay superimposed over the real-time view of the location based on the match.

5. The system of claim 1, wherein the first user interface includes at least one of the following: a registration selector, a location selector, a data entry form to input the commercial data, and a management module.

6. The system of claim 5, wherein the management module is configured to:
send and receive messages between the first user and the second user; and
update the commercial data based on the messages.

7. The system of claim 1, wherein the second user interface is configured to enable interactions of the second user with the AR overlay.

8. The system of claim 1, wherein the AR-enabled device includes one of the following: a smartphone, a tablet, a head-mounted display device, AR-enabled eyeglasses, a head-up display device, contact lenses, an AR-enabled windshield, and an AR headset.

9. The system of claim 1, wherein the AR overlay is implemented using an AR Software Development Kit.

10. The system of claim 1, wherein the AR overlay includes at least one of the following: virtual sensory input, virtual information about the environment and surrounding objects, sounds, visuals, videos, images, advertisements, information display, menu items, promotions, loyalty program information, virtual billboard, additional location information, restaurant information, and pricing information.

11. The system of claim 1, wherein the commercial data includes at least information related to real estate property associated with the first user, the real estate property being associated with the location; and
wherein the AR overlay viewable by the second user includes the information related to real estate property, the information being superimposed over the real-time view of the location.

12. A method for creating an augmented reality (AR) platform, the method comprising:
receiving, via a first user interface, commercial data from a first user, the commercial data being associated with a location;
automatically creating, by a processor, an AR overlay for the location based on the commercial data; and
rendering, via a second user interface associated with an AR-enabled device, the AR overlay superimposed over a real-time view of the location, the location being viewable by a second user through the AR-enabled device.

13. The method of claim 12, further comprising:
receiving a search request from the second user, the search request including an indication of an activation of the real-time view of the location by the AR-enabled device, the rendering of the AR overlay being performed based on the indication.

14. The method of claim 12, further comprising:
determining a current location of the AR-enabled device;
matching the current location of the AR-enabled device to the location; and
rendering the AR overlay superimposed over the real-time view of the location based on the match.

15. The method of claim 12, further comprising:
continuously collecting, by an artificial intelligence (AI) module, data associated with the second user and interactions of the second user with the AR overlay through the AR-enabled device;
analyzing, by the AI module, the collected data;
dynamically updating a personal profile of the second user based on the analysis; and
customizing, by the AI module, the AR overlay based on the updated personal profile.

16. The method of claim 15, further comprising:
based on the personal profile, classifying the second user, wherein the customization of the AR overlay is performed based on the classification.

17. The method of claim 15, wherein the customization of the AR overlay includes:
based on the commercial data, selecting one or more offers for the second user; and
displaying the one or more offers, via the AR overlay, to the second user.

18. The method of claim 17, wherein the one or more offers include one or more of the following: marketing materials, pricing materials, and informational materials, virtual sensory input, virtual information about the environment and surrounding objects, sounds, visuals, videos, images, advertisements, information display, menu items, promotions, loyalty program information, virtual billboard, additional location information, and restaurant information.

19. The method of claim 12, further comprising:
continuously collecting, by the AI module, behavioral data of the second user with regard to real-live objects; and
based on the behavioral data, selecting one or more offers for providing to the second user via the AR overlay.

20. A system for creating an augmented reality (AR) platform, the system comprising:
a first user interface configured to receive commercial data from a first user, the commercial data being associated with a location, wherein the commercial data includes at least information related to a real estate property associated with the first user;
a processor configured to:
receive a search request from a second user, the search request including an indication of an activation of a real-time view of the location by an AR-enabled device; and
automatically create an AR overlay for the location based on the commercial data, wherein the AR overlay is created based on the indication of the activation of the real-time view of the location by the AR-enabled device;
a second user interface associated with the AR-enabled device configured to render the AR overlay superimposed over the real-time view of the location, the location being viewable by the second user through the AR-enabled device, wherein the AR overlay includes the information related to real estate property; and
an artificial intelligence (AI) module comprising a bot configured to facilitate interactions between the first user and the second user.
